(19) United States
(12) Patent Application Publication
(10) Pub. No.: US 2026/0245269 A1
(43) Pub. Date: Aug. 20, 2026

(54) Method for Graphically Depicting Data of a Professional Profile

(71) Applicant: Yopaat B.V., Amsterdam (NL)

(72) Inventor: Huseyin Ozel, Amsterdam (NL)

(73) Assignee: Yopaat B.V., Amsterdam (NL)

(21) Appl. No.: 19/159,301

(22) PCT Filed: Mar. 30, 2023
(86) PCT No.: PCT/EP2023/058229

§ 371 Date: Aug. 22, 2025

(51) Int. Cl. G06T 11/26; G06Q 10/067

(52) U.S. Cl. CPC G06T 11/26; G06Q 10/067

(57) ABSTRACT

A computer implemented method for graphically depicting data of a professional profile, and in particular to a method involving receiving two or more sets of data of a professional profile, depicting respective circular trapezoids according to the data of the data sets of the professional profile, such that the relevant features and skills of the professional profile can be noticed with ease.

### OBJECT OF THE INVENTION

The present invention relates to a computer implemented method for graphically depicting data of a professional profile, and in particular to a method involving receiving two or more sets of data of a professional profile, depicting respective circular trapezoids according to the data of the data sets of the professional profile, such that the relevant features and skills of the professional profile can be noticed with ease.

### BACKGROUND OF THE INVENTION

The existing ways of presenting and comprehending data about a professional profile (such as the resume of an individual, definition of a job description, characteristics of a company) have many flaws and limitations. Professionals often rely on text-based documents on various software systems and websites to express, identify and analyse themselves, relevant other professionals to connect with, jobs to apply for, candidates to hire, and companies to do business with.

Writing, reading, and processing text-based documents is an ineffective way of expressing, identifying, and analysing professional individuals, jobs, or companies. Given that each résumé, job description and company profile is actually in a different format and each one lists skills in different granulation, it becomes extremely difficult to effectively generate, filter and grasp professional profiles.

For instance, in the field of recruitment, while assessing wrong candidates and wrong jobs are costly and time-consuming for individuals and businesses, actually ending up hiring the wrong individual for the wrong vacancy is even more costly as it causes lowered productivity, and wasted funds, resources, and opportunities for individuals and businesses. Although text-based résumés and job descriptions provide some level of information on professional profiles, the increasing amount of text-based professional profiles and information embedded in them make it overwhelming and difficult to specify, identify, and analyse the right matches swiftly. This is increasingly the case as the industries become further specialized and very specific job definitions emerge.

Text-based professional profiles in varying formats fall short for providing an accurate snapshot view into a professional profile and also fall short for providing a deeper view in a granular, structured fashion. Even with certain existing efforts for establishing standardized formats for professional profiles, the problem around quickly providing a snapshot brief and a detailed insight is not solved as text-based documents are hard to grasp while a precise mapping for industry fields and skills is not utilized.

### DESCRIPTION OF THE INVENTION

The present invention overcomes the limitations of the prior art by providing a method for graphically depicting data of a professional profile, a computer-readable storage medium, a computer program product, and a data carrier signal as described below.

In a first inventive aspect, the invention provides a method for graphically depicting data of a professional profile, wherein the method comprises, by a computing system with displaying means, the steps of:
receiving two or more sets of data of the professional profile, each set of data being associated with a professional skill, wherein each set of data comprises a value tuple with at least a first value and a second value;
depicting, on the displaying means, a first circular trapezoid associated to a first set of data, angle of the first circular trapezoid is proportional to a first value of the tuple of the first set of data, and the depth of the first circular trapezoid is proportional to a second value of the tuple of the first set of data;
depicting, on the displaying means, concentrically to, and non-overlapping the first circular trapezoid, a second circular trapezoid associated to a second set of data, wherein the angle of the second circular trapezoid is proportional to a first value of the tuple of the second set of data, and the depth of the second circular trapezoid is proportional to a second value of the tuple of the second set of data;
   wherein each circular trapezoid is defined by two concentrical circles of diameters D, d, and two radiuses separated by a circular arc of angle a, wherein the depth of the circular trapezoid is defined by the difference between the diameters D, d, and wherein the angle of the circular trapezoid is the angle of the circular arc.

Throughout the present description, professional profile should be understood as a set of information describing features and skills corresponding to an entity, which may be for example a physical person in search for a job, a job offer issued by a company, or an enterprise offering a job position, for example, for the purposes of publishing on online and offline media, and sharing information; in a embodiment, the information is previously included in a social network, in particular a professional social network for professional networking and career development.

It should be understood that the computer system can be a single conventional computer or a group of interconnected computers with access to a data communication network such as the Internet; in a preferred embodiment, the computing system is a user device, such as a smartphone or laptop. Also, the displaying means should be understood as any means capable of depicting or rendering a graphic pattern, wherein a preferred example of displaying means is the screen of a laptop or smartphone.

The set of data of a professional profile comprises two or more sets of data, each set of data corresponding to a specific skill. Examples of skills are the proficiency in a language, the expertise in particular software or the experience in a certain professional field. In turn, each set of data comprises a tuple, or array, of values, wherein each tuple comprises at least two values; the values may be, for example, a level of proficiency in a language, the level of expertise with a particular software or the number of years of experience in a certain professional field. The values may be integers, percentages, rational numbers, floating point values, binary values, alphabetical characters, or combinations thereof. The professional profile preferably comprises further information such as an identification of the candidate or the company, identification of each skill, and other relevant details.

According to the method, each skill, represented by a set of data, is graphically depicted on the displaying means by a circular trapezoid, or slice, or simply, trapezoid; a circular trapezoid should be understood as the region of space enclosed by two arcs of respective concentrical circles and two line segments passing through the centre of the circles; thus, the dimensions of each circular trapezoid is characterized by the larger and smaller diameters of the concentrical circles, D, d, respectively, and the angle formed by the two line segments, a. By non-overlapping should be understood that, in a depiction of the trapezoids neither the segments nor the arcs of the perimeter of a trapezoid intersect the segments or arcs of another trapezoid. In some embodiments, a segment or an arc of a trapezoid, or a portion of them, may be parallel or coincidental with a segment of another trapezoid.

The resulting arrangement, or graph, of the two or more circular trapezoids, sharing a common centre and non-overlapping, represents the set of professional skills of an entity. Advantageously, the method may be executed as a part of a computing process, for example, the retrieval of a profile by a user from a website or a social network. Accordingly, the dimensions and position of the trapezoids enable for a fast recognition of the knowledge and expertise level of a skill of a professional profile.

In a particular embodiment, the method further comprises, by the computing system, the steps of:
receiving a third set of data of the professional profile;
depicting, on the displaying means, concentrically to, and non-overlapping the first and second circular trapezoids, a third circular trapezoid associated to the third set of data;
   wherein the smaller diameter, d, of the third circular trapezoid is equal to or larger than the largest diameter, D, of any of the first and second circular trapezoids.

According to this particular embodiment, a third set of data may be depicted with a third circular trapezoid in addition to the first and second data sets, wherein the third circular trapezoid is depicted at a greater distance from the centre than the first and second circular trapezoids. Advantageously, with a combination of arrangements of depictions of circular trapezoids, it is possible to represent a large number of professional skills in a single graph. In a preferred embodiment, the computer system may receive further sets of data, any of which may be represented according to the process for the first, second or third sets of data.

In a particular embodiment, the method further comprises, by the computing system, the steps of:
receiving an entity set of data of the professional profile;
depicting, on the displaying means, concentrically to, and non-overlapping the first and second circular trapezoids, a circle associated to the entity set of data;
   wherein the diameter of the circle is equal to or smaller than the smallest diameter, d, of any of the circular trapezoids.

An entity set of data preferably comprises additional information of the entity represented by the professional profile, such as the name of the entity, a distinguishing image or symbol, and may be depicted on a circle at the centre of the graph.

In a particular embodiment, the diameters D, d, of the first and second circular trapezoids have the same value. Advantageously, a first and a second circular trapezoids have each the same values of the corresponding larger and smaller diameter, such that both circular trapezoids are arranged at the same distance from the common centre of the graph, and have the same depth, or difference between the larger and smaller diameters. In an embodiment, several circular trapezoids are arranged in this fashion, substantially forming an annulus or ring-shaped form.

In a particular embodiment, the depth of the second circular trapezoid is proportional to an integer multiple of the depth of the first circular trapezoid, and/or the depth of the third circular trapezoid is proportional to an integer multiple of the depth of the first or the second circular trapezoid. Advantageously, the depths, or differences between D and d, of two of the circular trapezoids has a ratio equal to an integer.

In a particular embodiment, the angles of any of the first, second and/or third circular trapezoids have the same value. Advantageously, a plurality of circular trapezoids have the same angle, which might be used to mean that they represent several skills of the same category, for example language proficiency. In a particular embodiment, the value of the angle of any of the first, second or third circular trapezoids is one of: 6°, 18°, 90°.

In a particular embodiment, at least one of the sets of data comprises an information item of the corresponding professional skill, and the method further comprises, by the computing system, the step of:
depicting, on the displaying means, the information item on the circular trapezoid, or the circle, associated to the set of data.

An information item should be understood as a data item different from a numerical value, such as for example, an image or a text string. Advantageously, the information item allows for the inclusion of additional information, which might be useful, for example, to identify a professional skill. In a particular embodiment, the information item is one or more of: a numerical value, a string of text, a photograph, an image, a symbol.

In a second inventive aspect, the invention provides a computer readable medium comprising instructions which, when executed by a computer, cause the computer to carry out the steps of the method of the first inventive aspect.

The computer readable-storage medium may be, in an embodiment, a FLASH memory unit, configured to be distributed. In other embodiments, the computer readable-storage medium is a hard disk unit or a solid-state disk, SSD, unit.

In a third inventive aspect, the invention provides a computer program product comprising instructions which, when the program is executed by a computer, cause the computer to carry out the method of the first inventive aspect.

The computer program product may be designed such that it can be installed on a user device. It may also be configured such that parts of the computer program product are executed on a client computer, while other parts are executed on a server computer, both computers being interconnected by means of a data network. In an embodiment, several copies of the product parts intended to be executed by client computers are operated by one or more job candidates or one or more companies.

In a fourth inventive aspect, the invention provides a data carrier signal carrying the computer program of the first inventive aspect.

### DESCRIPTION OF THE DRAWINGS

The foregoing and other advantages and features will be more fully understood from the following detailed description of exemplary embodiments with reference to the accompanying drawings, which should be considered by way of illustration and not limitation, in which:

FIGS. 1a-1e These figures represent flow diagrams of preferred embodiments of the method.

FIG. 2 This figure represents a possible depiction of a professional profile according to an embodiment of the invention.

FIG. 3 This figure shows the main dimensions of a circular trapezoid.

### PREFERRED EMBODIMENT OF THE INVENTION

Throughout the present document it will be understood that various parts of one embodiment of the invention can be freely combined with parts described in other embodiments, even being said combination not explicitly described, provided there is no harm in such combination.

In this example, the method is intended to be executed in a conventional computer system such as a smartphone or laptop in data communication with the Internet or another data network, wherein displaying means are implemented in the computer system by means of a screen, and the sets of data are provided over the data network by a remote server hosting at least a part of a website; to this end, the server comprises data storage means where the sets of data have been previously provided by the entities and stored.

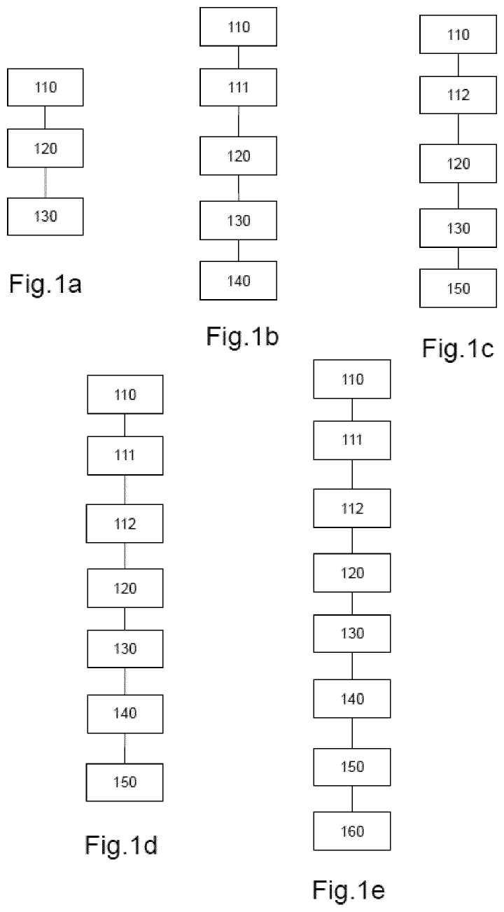

FIGS. 1a-1e show examples of the method for depicting a professional profile. In the example shown in FIG. 1a, the computing system, prompted by a user, receives (110) at least first and second data sets of a professional profile from the server.

Then, the first circular trapezoid (1) and the second circular trapezoid (2) are depicted (120, 130) on the displaying means; the process is repeated as many times as required to depict further sets of data.

In another example, shown in FIG. 1b, the computing system receives (111) a third set of data and depicts (140) a third circular trapezoid (3) at a greater distance from the centre than the first and second circular trapezoids (1, 2).

In another example, shown in FIG. 1c, the computing system receives (112) an entity set of data and depicts (150) a circle (4) at a smaller distance from the centre than the first and second circular trapezoids (1, 2).

FIG. 1d shows a combination of the previous examples. Also in another example, as shown in FIG. 1e, the computing system depicts (160) an information item (5) on any of the circular trapezoids (1, 2, 3) or the circle (4); this information item (5) can be, in an example, a text label describing the professional skill corresponding to the circular trapezoids (1, 2, 3), or a name of an entity on the circle (5).

According to a preferred embodiment of the invention, a professional profile graph provides a snapshot view into a professional's skill-set, such as industry-independent professional skills (principal (soft) skills, main productivity skills, language skills) and industry skills (cross-industry skills and industry-specific skills). In the example, there are three different types of entity charts corresponding to three different entity types: professional profile charts, vacancy charts, enterprise profile charts.
A professional profile chart provides a snapshot view into a professional's skill-set, such as industry-independent professional skills (principal (soft) skills, main productivity skills, language skills) and industry skills (cross-industry skills and industry-specific skills).
A vacancy chart provides a snapshot view into a vacancy's skill requirements, such as industry-independent professional skills (principal (soft) skills, main productivity skills, language skills) and industry skills (cross-industry skills and industry-specific skills).
An enterprise profile chart provides a snapshot view into an enterprise's details, such as its essential type, business models, number of employees, geographical presence, and specializations across various industries.

The information items (5) may help represent these fields. Further, two or more related skills may be represented by means of circular trapezoids with the same angle, for example, sets of circular trapezoids with an angle a of 6°, 18°, or 90°. A relationship between two or more related skills may as well be represented by grouping the circular trapezoids at the same distance from the centre, and having the same depth. In other examples, a value of a skill may be represented by the depth, D-d, or the angle a of the corresponding circular trapezoid. Furthermore, the depth of a circular trapezoid may be dependent on the depth of a different circular trapezoid, for example, the depth of a first circular trapezoid (1) may be twice the depth of a third circular trapezoid (3).

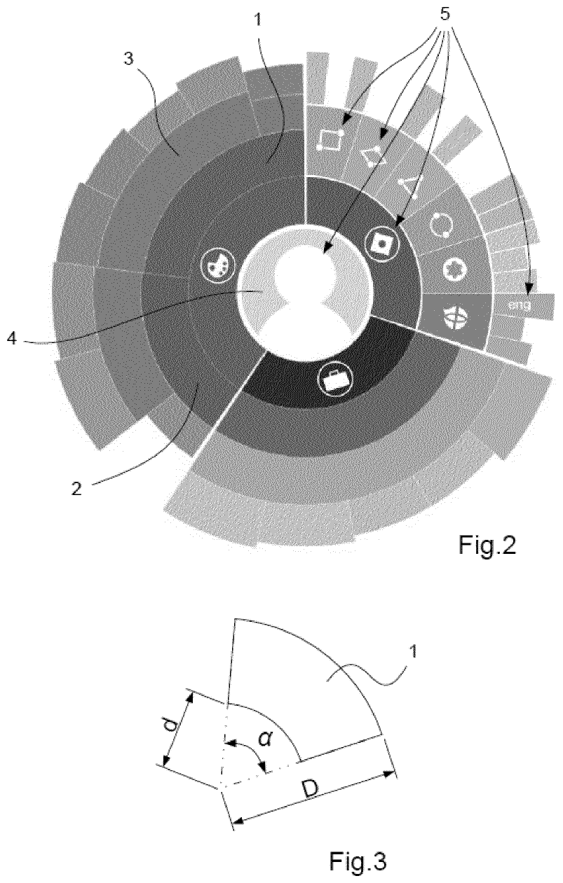

FIG. 2 shows an example of the resulting depiction, or graph, as in the example of FIG. 1e. The figure shows a graph with up to forty-one circular trapezoids (1, 2, 3), a circle (4) at the centre of the graph, and a number of information items (5) on some of the fields; the figure represents for example, a silhouette of an entity on the circle (4), and symbols referring to the skills represented by one or a group of circular trapezoids (1, 2, 3).

FIG. 3 shows the main dimensions of a first circular trapezoid (1), namely the larger diameter, D, the smaller diameter, d, and the angle formed by the segments, a.

1. Method for graphically depicting data of a professional profile, wherein the method comprises, by a computing system with displaying means, the steps of:
receiving two or more sets of data of the professional profile, each set of data being associated with a professional skill, wherein each set of data comprises a value tuple with at least a first value and a second value;
depicting, on the displaying means, a first circular trapezoid associated to a first set of data, wherein the angle of the first circular trapezoid is proportional to a first value of the tuple of the first set of data, and the depth of the first circular trapezoid is proportional to a second value of the tuple of the first set of data;
depicting, on the displaying means, concentrically to, and non-overlapping the first circular trapezoid, a second circular trapezoid associated to a second set of data, wherein the angle of the second circular trapezoid is proportional to a first value of the tuple of the second set of data, and the depth of the second circular trapezoid is proportional to a second value of the tuple of the second set of data;
wherein each circular trapezoid is defined by two concentrical circles of diameters, and two radiuses separated by a circular arc of angle, wherein the depth of the circular trapezoid is defined by the difference between the diameters, and wherein the angle of the circular trapezoid is the angle of the circular arc.

2. Method according to claim 1, wherein the method further comprises, by the computing system, the steps of:
receiving a third set of data of the professional profile;
depicting, on the displaying means, concentrically to, and non-overlapping the first and second circular trapezoids, a third circular trapezoid associated to the third set of data;
wherein the smaller diameter of the third circular trapezoid is equal to or larger than the largest diameter of any of the first and second circular trapezoids.

3. Method according to claim 1, wherein the method further comprises, by the computing system, the steps of:
receiving an entity set of data of the professional profile;
depicting, on the displaying means, concentrically to, and non-overlapping the first and second circular trapezoids, a circle associated to the entity set of data;
wherein the diameter of the circle is equal to or smaller than the smallest diameter of any of the circular trapezoids.

4. Method according to claim 1, wherein the diameters of the first and second circular trapezoids have the same value.

5. Method according to claim 1, wherein the depth of the second circular trapezoid is proportional to an integer multiple of the depth of the first circular trapezoid, and/or the depth of the third circular trapezoid is proportional to an integer multiple of the depth of the first or the second circular trapezoid.

6. Method according to claim 1, wherein the angles of any of the first, second and/or third circular trapezoids have the same value.

7. Method according to claim 6, wherein the value of the angle of any of the first, second or third circular trapezoids is one of: 6°, 18°, 90°.

8. Method according to claim 1, wherein at least one of the sets of data comprises an information item of the corresponding professional skill, and the method further comprises, by the computing system, the step of:
depicting, on the displaying means, the information item on the circular trapezoid, or the circle, associated to the set of data.

9. Method according to claim 8, wherein the information item is one or more of: a numerical value, a string of text, a photograph, an image, a symbol.

10. Computer readable medium comprising instructions which, when executed by a computer, cause the computer to carry out the steps of the method of claim 1.

11. Computer program product comprising instructions which, when the program is executed by a computer, cause the computer to carry out the method of claim 1.

12. Data carrier signal carrying the computer program of claim 1.
